(19) United States
(12) Patent Application Publication
(10) Pub. No.: US 2010/0154931 A1
(43) Pub. Date: Jun. 24, 2010

(54) Guide Assembly for a Cutting Tool

(76) Inventor: Cameron Mclean Downie, St. Ouens (GB)

Correspondence Address: RICHARD M. GOLDBERG, 25 EAST SALEM STREET, SUITE 419, HACKENSACK, NJ, 07601, US

(21) Appl. No.: 12/641,506

(22) Filed: Dec. 18, 2009

(30) Foreign Application Priority Data
Dec. 18, 2008 (GB) 0823095.5
Aug. 24, 2009 (GB) 0914693.7

(51) Int. Cl. B27C 5/04

(52) U.S. Cl. 144/144.52

(57) ABSTRACT

A cutting guide assembly (5) for assisting the modification of a work piece (142) by a cutting tool (47) includes a support surface (125) for receiving and supporting a work piece (142); a guide member (110) including a guide edge (108) for guiding the cutting tool (47); an adjustable stop member (106) configured for abutment with the work piece (142) to locate the work piece (142) in a cutting position relative to the guide edge (108). A selected portion of the work piece (142) is aligned with the guide edge (108). At least one clamp (160) is arranged to clamp the work piece (142) in said cutting position. The guide member (110) is fixed in position and the adjustable stop member (106) is movable relative to the guide member (110) to selectively locate the work piece (142) in a plurality of cutting positions relative to the guide edge (108).

The present invention relates to a guide assembly and in particular to a cutting guide for a router.

Providing a well fitting door with a quality finished edge is a common problem faced by carpenters and joiners involved with on site construction and door hanging. Most on site door fitting is bespoke as frame sizes vary, and door outer dimensions need to be adjusted to fit. When a door is formed to fit a frame in a workshop, this work is carried with heavy duty power driven workshop machinery which enables a high quality edge finish to be achieved. Out of the workshop environment it is very difficult to achieve the same accuracy and finish. Typical on site adjustment of a door usually involves sawing or planing small amounts of material from the door edges, with straight edges being judged by eye, which is a timely and often inaccurate process.

It is known to power tools such as routers to remove excess material more quickly and achieve an improved edge finish. However, the speed of power driven cutting tools increases the likelihood of deviation from a cutting line if working by eye. As such a guide edge is required if an acceptable straight edge is to be achieved.

US patent number 2008/0121311 describes a guide system for enabling multiple channelled cuts to be made in a work piece. The system comprises multiple adjustable guides which clamp the work piece to a support surface and also provide guide edges for guiding the action of a router. However, such a complex assembly is unsuitable for working large pieces such as doors, and is intended for use in a workshop and is therefore unsuitable for portable use. In addition, it has been found that adjustable guide edges of this type are prone to movement during cutting, therefore providing an inaccurate cut. GB 2287208 and GB 2208071 also show examples of cutting guide systems having adjustable guide edges.

It is therefore desirable to provide an improved cutting guide assembly which enables an accurate and high quality finish to be provided to a work piece, addresses the above described problems and/or which offers improvements generally.

According to the present invention there is provided a cutting guide assembly as described in the accompanying claims.

In an embodiment of the invention there is provided a cutting guide assembly for assisting the modification of a work piece by a cutting tool. The assembly comprises a support surface for receiving and supporting a work piece; a guide member comprising a guide edge for guiding the action of said cutting tool; an adjustable stop member configured for abutment with the work piece to locate the work piece in a cutting position relative to the guide edge whereby a selected portion of the work piece is aligned with the guide edge; and at least one clamp arranged to clamp the work piece in said cutting position. The guide member is fixed in position and the adjustable stop member is movable relative to the guide member to selectively locate the work piece in a plurality of cutting positions relative to the guide edge.

The fixed guide edge and a movable stop member for aligning the work piece with the guide edge prevent movement of the guide edge during cutting associated with an adjustable guide edge, and thereby ensure an accurate and consistent straight edge cut. In addition, providing a fixed cutting guide edge obviates the requirement for complex and/or highly toleranced guide edge adjustment mechanisms thereby reducing cost and simplifying manufacture.

The cutting support surface defines a support plane and the stop member may linearly moveable parallel to the support plane in a direction perpendicular to the guide edge to vary the depth of cut of the cutting tool, with an increased distance from the guide edge to the stop member corresponding to a decreased cutting depth.

The stop member may also be rotatable parallel to the support plane and relative to the guide edge to vary the angle of cut of the cutting tool. This enables the front working edge of the work piece aligned with the guide edge to be cut in a direction non-parallel to the rear edge abutting the stop member.

The cutting guide assembly may comprise a support frame to which the guide member and stop member are mounted. The support frame may comprise a table or similar structure. The guide member is fixed relative to the support frame, and the stop member is movable relative to the support frame and the guide member.

The support frame may comprise at least one frame member defining a guide rail. The stop member may be slideably mounted to the guide rail to enable the moveable adjustment of the stop member relative to the guide edge. As such, the guide rail enables consistent, repeatable and accurate linear adjustment of the stop member relative to the guide edge.

Preferably the stop member comprises at least one connector for slideably mounting the stop member to the at least one guide rail. The connector may include locking means configured for locking the stop member in a plurality of positions along the guide rail, and hence locking the stop member in position relative to the guide member.

The stop member may be movably mounted to the locking means and the connector may further comprise adjustment means for moving and selectively adjusting the position of the stop member relative to the locking means to enable further positional adjustment of the stop member relative to the guide edge when the locking means is locked to the guide rail. In this way, the locking means may be used to provide course and rapid adjustment of the stop member, and the adjuster used to provide finer adjustment once the course locking position has been set.

Each guide rail may comprise a plurality of locking points configured for engagement by the locking means to lock the stop member in said plurality of positions. Each of the locking points may define a cutting position. Preferably the locking points are evenly spaced and provide regular indexed cutting positions.

The stop member may be slideably mounted to the locking means. The adjuster may comprise a threaded actuator having a first threaded portion fixed to the locking means and a second threaded portion engaged with the first threaded portion and rotatably connected to the stop member such that relative rotation of the first and second threaded portions causes movement of the stop member relative to the locking means.

The cutting guide may comprise two guide rails arranged parallel to each other. The stop member comprises two connectors mounted to said two guide rails. The stop member is pivotably mounted to a first one of the two connectors and slideably and pivotably mounted to a second one of the two connectors such that the stop member is able to slide relative to the second connector while pivoting about the first connector to enable angular adjustment of the stop member relative to the guide edge by independently positioning said connectors at varying positions from the guide edge along said guide rails. This enables the front edge of the work piece to be cut a non-parallel angle relative the rear reference edge abutting the stop member.

The at least one clamp may be mounted to the stop member. Preferably a plurality of clamps is mounted to the stop member to optimise the security of the work piece.

A portion of the support surface may connected to and movable with the stop member. A further fixed support surface is provided proximate the guide edge. A support surface may be provided corresponding to each of the clamps to provide the clamps with an opposing clamping surface to clamp. Providing movable support surface portions ensures that the work piece is suitably supported, while obviating the requirement for a complete single support surface spanning the entire upper surface of the cutting guide, thereby reducing material and hence weight and cost of the cutting guide.

The guide member may comprise a channel member having an inner section with an upper surface forming a portion of the support surface and an inner side wall defining the guide edge, and an outer section having an upper tool support surface configured to support said cutting tool during cutting of the work piece. The inner section and outer section are interconnected at their base and define a channel therebetween for receiving the tool bit of the cutting tool in use. The channel thereby enables the cutting tool to be supported during cutting while also accommodating the cutting blade and prevent interference with the work piece support surface.

The outer section of the channel member may comprise a movable portion which is adjustable to vary the height of the tool support surface. This enables the tool support surface to be vertically aligned with the upper surface of the work piece, such that when the tool is partially supported on the work piece it may simultaneously be partially supported by the tool support surface at an equivalent vertical position to maintain a level orientation.

The cutting guide assembly may comprise an arrangement of collapsible legs for supporting the support surface in an elevated position, the legs being collapsible from a support position to a stowed position to assist transit and/or storage.

The present invention therefore provides a reliable method of achieving both conformity of fit combined with a high quality of finish to the door edges. The invention may also be used to straighten several sheets of material to gain good alignment or abutment as a means to construct cabinets, moulds or similar constructions.

The portable clamping and machining frame is provided on a chassis which may be deformable for ease of transport, or assembled from several easily transportable sub assemblies.

An example would be the provision of a main chassis consisting of four main members formed as an accurate rectangle having corner angles of 90°. Each member may be demounted for transport and reassembled on site. The frame corners may be provided with hinges to enable folding, and may for example be in the form of a parallelogram. Each member may be constructed as steel pressing or an aluminium extrusion. A sliding rail profile may formed on the outside, or inside of the frame members to enable the attachment of other chassis members and or devices to assist the functionality of the device.

The sliding rail may extend the length of each member. Several sliding rail systems may be provided to carry out various clamping or support requirements. The angle of each corner of the assembled frame may be locked at 90°. In order that the integrity of this angle is maintained as a datum, corner bracing may be employed. One preferred method would be triangular plate positioned at each corner and formed as a right angle triangle. One side edge opposite the hypotenuse may be permanently fixed to one of the members of the parallelogram whilst the other may provided with temporary attachment method.

The main chassis provides an accurate platform, to which the door clamping and machining equipment may be attached to. The chassis may be provided with its own adjustable legs or detachable trestles, or may be laid on the stands, or benches usually found where carpenter and joiners are working.

At the front of the chassis there may be provided a further guide edge machining guide which may be attached to the chassis via two lead screws adjusters positioned at either end of the machining guide. Hand driven cranks may be provided to drive the lead screws, the machine guide is provided with a swivel arrangement at either end which is mounted on plumber blocks conveniently near the adjustment cranks. The swivel arrangement allowing each screw adjuster to move independently to enable angular cuts to a work piece. The machining guide may be positioned by rotating the lead screws in or out thus providing adjustment to both the work pieces width and angle of cut on the X axis. A further machining guide may be placed at one end of the X axis. This guide provides machining in the Y axis. To provide angle correction to the X and Y axis the machining guides are provided with an angle adjuster. To ensure continuous machining the X and Y machining guides may be attached to one another at their intersections.

Any of the leading edges of the guide edge machining guides may be provided with a disposable protective edging to prevent damage on the occasion of the operator misaligning the router tool.

To alter a work piece such as a door the back stop may be conveniently positioned at a point that a door or sheet can be laid on the chassis. The back stop may be set at a pre-measured position. The door or sheet is positioned with its edge up against the back stop where it may be clamped ensuring sufficient edge overlap of the guide edge machining guides. When the work piece is in position it lays freely on the machining guide, the weight of the work piece and operator contact with the router being sufficient to maintain good contact with the guide, final adjustments may be carried out by operating the lead screw adjustment without the impediment of clamps being affixed to the work piece and the machining guides. After the work piece is positioned correctly the operator positions a conveniently tooled router, the cutting bit preferably provided with a roller bearing positioned conveniently at the non driven end of the shank which provides the engagement point with the machining guide. The operator places the bed of the router on the work piece at suitable point. The router guide bearing is positioned against the machining guide.

To make a cut the operator may start the router motor and push the router forwards into the work piece, ensuring good contact of the guide roller bearing of the cutter with the machining guide. This may be achieved by exerting a small amount of side pressure in the direction of the work piece while pushing the router through to cut. Assuming clockwise rotation of the router tool bit, the router will tend to draw the router to the bulk of the sheet or door and therefore maintain good contact with machine guide edge this leaves the operator with simply supporting and operating the router.

The backstop may be provided with lead screws and the machine guide edge may be fixed. The backstop being adjusted by the operator to appropriate position. Measurement increments may be indicated by visual increments marked on the chassis, or by electronic means such as an electronically readable track and a electronic reading device which may translate impulses or magnetic signatures which register the position of the backstop or, front machine guide edge on a led screen placed in view of the operator at the tables operational position, the led screen encasement may be provided with a recording device to memorise previously used dimensions.

Pattern profiles may be attached to the work piece or machine guide edges. In this arrangement the router bit is provided with a bearing which is attached to the router bit shank near the clutch or attachment coupling. The door or sheet being positioned on the frame to avoid any collision with the machine guide edge. The machine guide edge may substituted with a further guide to machine dovetail joints, angled cuts, pattern holders to machine cavities or recesses to install hinges and door locks. Several sheets may be machined simultaneously to provide identical pairs.

A front clamping mechanism may be introduced which may consist of a longitudinal bridge member which straddles the area of the door which it is desired to machine. The front mechanism is conveniently provided with adjustment to accept various thicknesses of material which could be a door or sheet of composite material. The leading edge of the bridge member may also form the machining guide on which the router guide roller may rest. To ensure accurate vertical movement the camping mechanism is provided with a machined guide on the Z axis. A further pivot may be added to this mechanism which provides alternative machining angles.

The router may be power fed by providing a track and clamping device which may accommodate a router. The track may be mounted on a bridge arrangement and mounted on the adjustable guide edge mechanism. Drive means may be a crawler device which the router is mounted on or a recirculating chain or toothed belt, conveniently driven from one end and tensioned by an idler pulley at the other end, the router carriage being attached to the belt. Speed of cut and start and stop points may be provided by electrical or mechanical means. This facility may also be positioned below the work piece.

The present invention will now be described by way of example only with reference to the following illustrative figures in which:

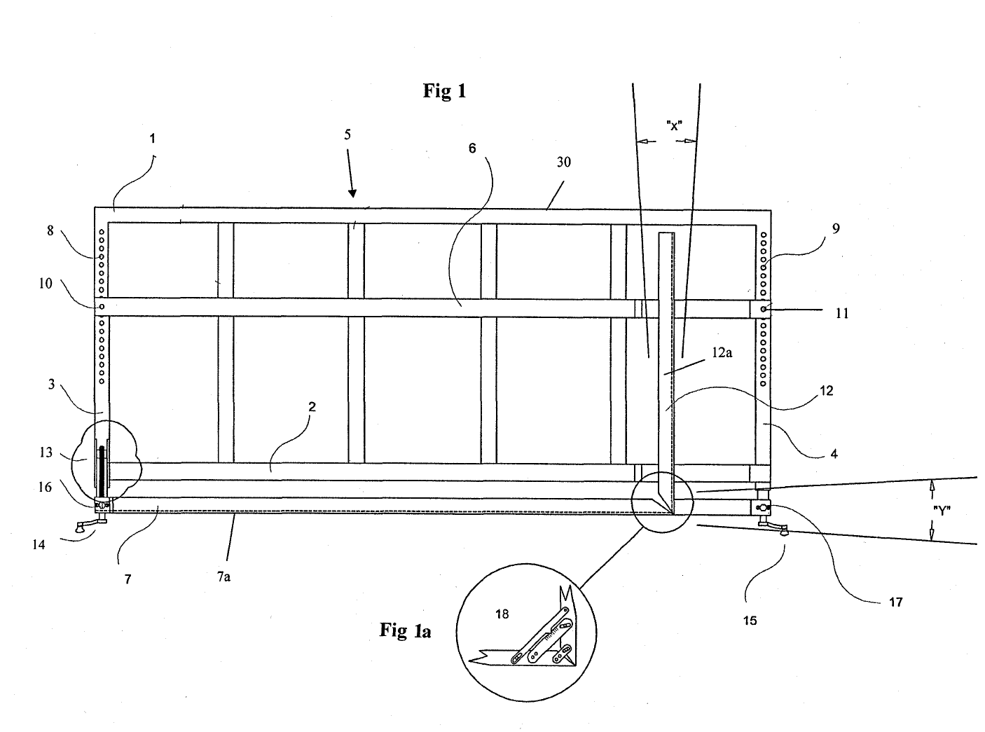

FIG. 1 is a plan view of a router table according to an embodiment of the present invention;

FIG. 1a is a more detailed view of the guide edge angle adjustment mechanism of FIG. 1;

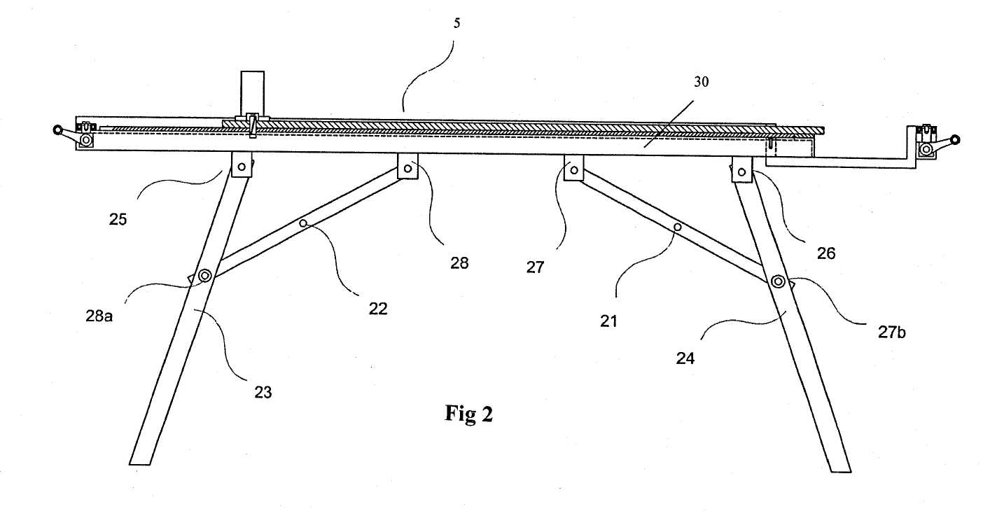

FIG. 2 is a side view of the router table of FIG. 1;

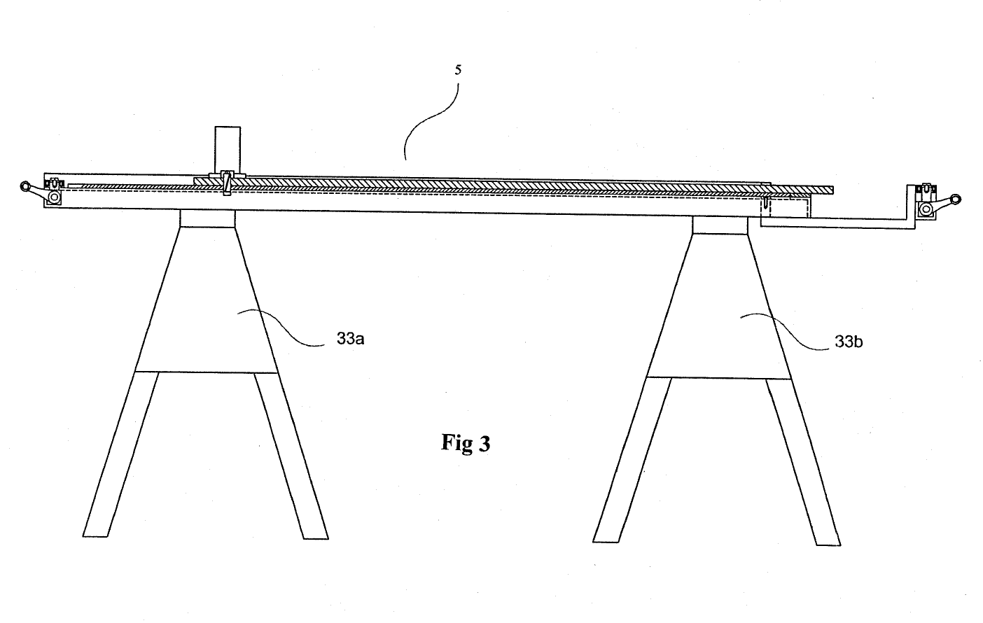

FIG. 3 is side view of a router table in accordance with another embodiment of the invention similar to that shown in FIGS. 1 and 2 but including an alternative support structure;

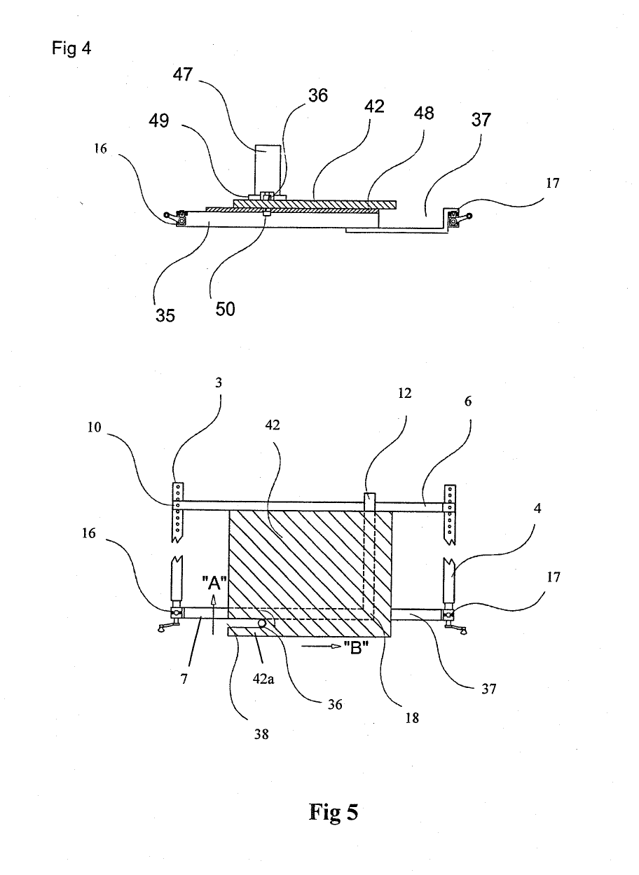

FIG. 4 is a side view of the router table shown in FIG. 1 or 3 with a work piece clamping in position;

FIG. 5 is a plan view of the router table of FIG. 4 with only the router cutter shown;

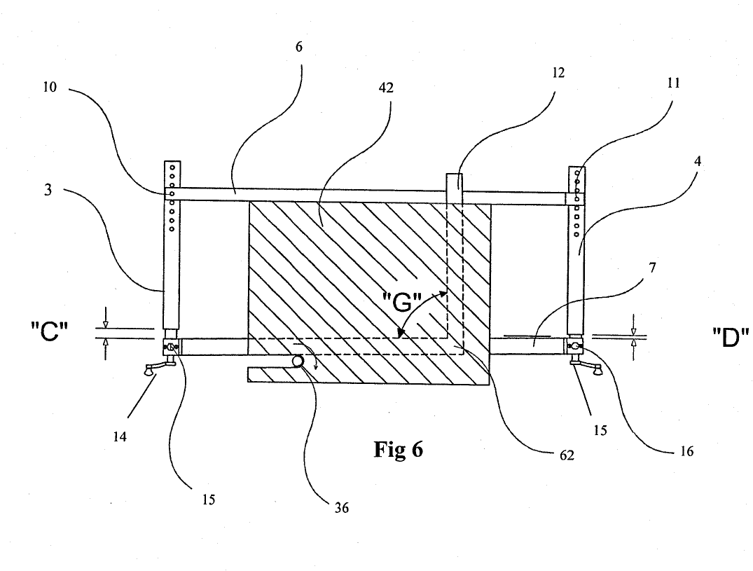

FIG. 6 shows the router table of FIG. 5 with the guide oriented at an angle to the work piece;

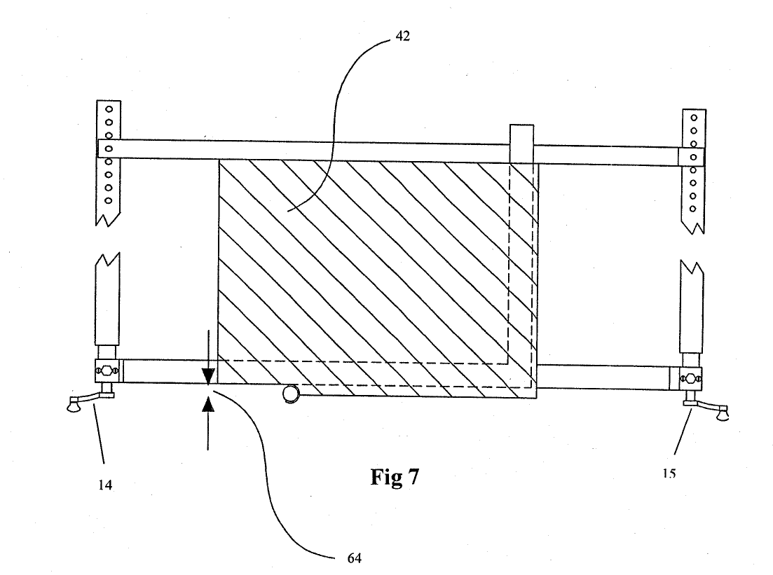

FIG. 7 shows the router table of FIG. 5 with a guide edge set to provide a fine depth cut;

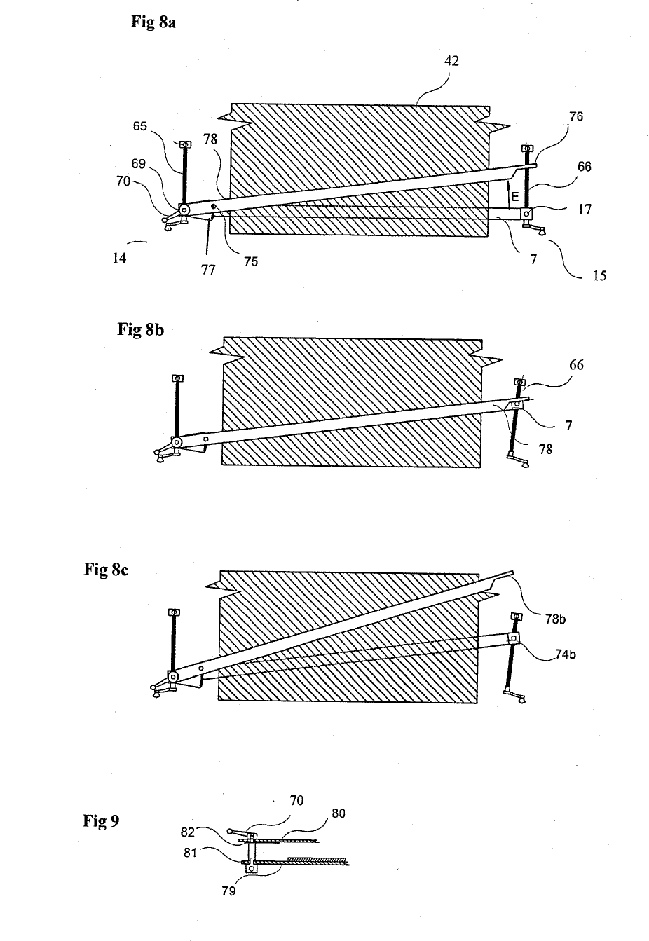

FIGS. 8a-c are schematic representations of a router table according to another embodiment of the invention including a angle adjustment guide;

FIG. 9 is side view of the guide edge angle adjuster of FIG. 9a-c;

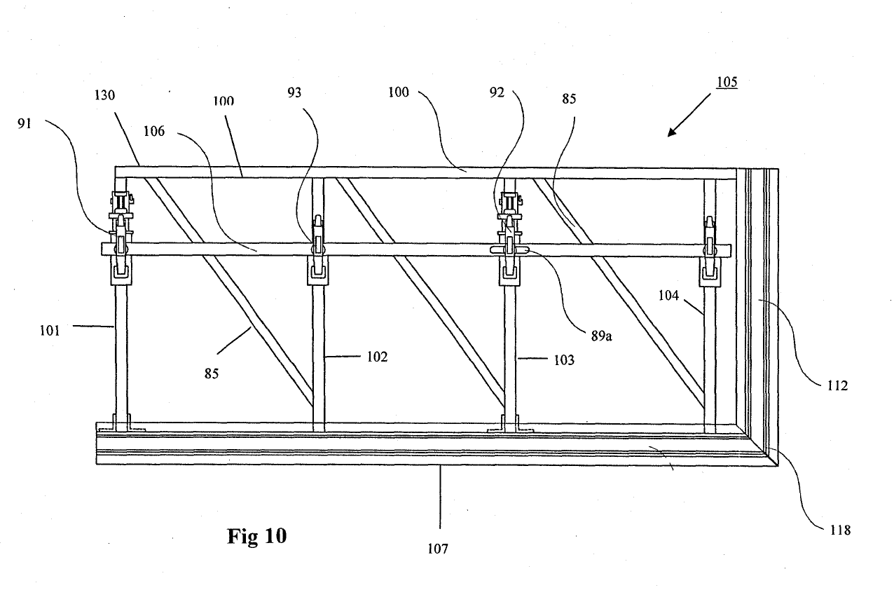

FIG. 10 is a plan view of a router table according to a further embodiment of the invention; and

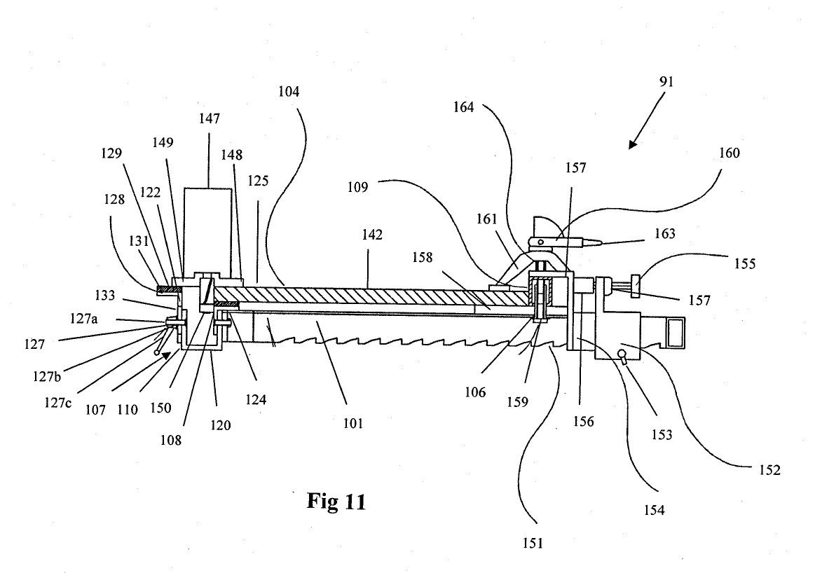

FIG. 11 is a section view of the router table of FIG. 10.

Referring to FIG. 1, a router table 5 comprises a frame 30 formed from a plurality of rigid beams 1, 2, 3 and 4. A plurality of rigid cross members provides bracing for the frame. A back stop 6 is provided for positioning and retention of a work piece which may be a door, sheet of composite material or laminate. The back stop 6 comprises attachment points 10 and 11 which are selectively securable to a plurality fixing points 8 and 9 on the frame members 3 and 4. A front mounted machine guide member 7 comprising an outer guide edge 7a is attached to the front edge of the frame 30. By fixing the attachment points 10 and 11 to selected fixing points 8 and 9 the position of the back stop 6 may be altered relative to the guide edge 7a. Varying the relative distance between the back stop 6 and the guide edge 7a varies the depth of cut of the router 47.

The guide member is attached to the frame 30 via hand driven lead screws 14 and 15. The guide member 7 extends substantially along a horizontal first X axis. As can be seen from exposed cross sectional view 13, a sliding joint is provided within the frame member 3 which is actuated by a hand driven lead screw 14. A similar arrangement is provided within frame member 4 with a lead screw 15. The lead screw arrangement provides depth adjustment to guide member 7 to move the guide edge 7a linearly towards and away from the frame 30.

A second guide member 12 having an outer guide edge 12a is also provided which extends along a second Y axis. The X axis guide member 7 and Y axis guide member 12 are pivotable relative to each other about adjustable joint 18. The lead screw adjustors 16 and 17 enable angle changes to the X axis guide edge in the Y axis direction, while adjustment joint 18 provides angular adjustment of the Y axis guide edge in the X axis direction to enable the angle of cut to be varied.

Folding legs 23 and 24, are attached to the frame 30 at points 25 and 26. Folding struts 21 and 22 are attached to frame 30 at attachment points 27 and 28 and to the legs at attachment point 27a and 28b. The legs 23 and 24 support the frame 30 at a suitable height spaced from the ground for a router operator to work on a work piece 42 supported on the frame 30. Alternatively the frame 30 may be supported on carpenters' trestles 33a and 33b, as shown in FIG. 3.

As shown in FIG. 4, to modify a work piece 42 the work piece 42 is abutted and clamped against back stop 6. Typically a router 47 is used to remove a relatively fine amount of the work piece 42 to provide the work piece 42 with a quality edge finish. In the example arrangement shown in FIG. 4 the work piece 42 is somewhat larger than the finishing capability of the router bit 36, with the router bit 36 cutting through the work piece 42 such that an off cut 42a remains after machining is completed.

To conduct a cut, the operator places the router bed 49 of the router 47 at cut start point 38 relative to work piece 42, such that guide bearing 50 abuts the machine guide member 7. The operator activates the router 47 and pushes it into the work piece 42 in direction “B” along the X axis. The router bit 36 includes a router cutter bearing 50 which engages the guide edge and prevents contact between the guide member 7 and the cutting bit 36. Starting the motor of router 47 and engaging router cutter bit 36 against work piece 42 drives the router cutter bearing 50 against the machine guide edge 7a in the general direction of “A” provided the router cutter bit 36 rotates in a clockwise rotation and travels left to right in direction “B”.

A further cut may be made to the work piece 42 across the table along the Y axis in the direction A. To ensure that the work piece is supported in a level arrangement on the guide members 7 and 12, the guide member 12 located in same horizontal plane as the guide member 7. The frame 30, including the adjustable front edge machine guide member 7, is provided with a step 37 to give working clearance to the router cutter bit 36 when working in the Y direction.

To afford protection to the machining guide edges 7a and 12a, replaceable wear/collision strips 48 are attached to the upper surfaces of the guide members 7 and 12 adjacent the guide edges 7a and 12a.

To provide an angled cut to the work piece 42, the back stop 6 may have its angular position adjusted relative to the guide edge 7a by adjusting the attachment points 10 and 11 of the back stop 6 fix them to non-corresponding fixing points 8 and 9 along the frame members 3 and 4 located at varying distances from the guide edge 7a, such that the distance of the attachment point 10 from the guide edge 7a is different to that of the attachment point 11. Alternatively, as shown in FIG. 6, angle and depth adjustment of the X axis machining guide edge 7a may be made by altering the lead screw adjusters 14 and 15. To create an angled cut the Y axis winding distance C of the first lead screw 14 is varied from the winding distance D of the second lead screw 15. Angular adjustment of the Y axis guide edge 12a may be provided by adjusting angle G at intersection 62 between guide members 7 and 12 using adjustable joint 18.

The cutting guide 7 may be used to provide fine, or edge finishing capability where only small amounts of material may have to be removed from work piece 42 as shown in FIG. 7. This is achieved by adjusting the distance of the guide edge 7a to provide a small cutting depth 64. The fine adjustment capability provide by the lead screws 14 and 15 enable such fine finishing to be achieved.

As shown in FIGS. 9a-c, an angle adjustment guide 78 may be provided to assist in setting the angle of the guide member 7. As the two lead screw adjusters are adjusted independently to one another, setting accurate machining angles can be difficult if done by eye. The angle adjuster 78 assists in setting the cutting angle by providing an adjustable guide to which the guide member 7 can be moved. In use the operator clamps the work piece 42 to the routing table 5. The operator is then able to set the required cutting angle E by rotating the guide 78 around pivot point 69. Once the required angle has been achieved, the angle adjuster 78 is locked in position by lever nut 70 which is attached to the housing of the lead screw 65. An angle gauge 77 is fixed to the pivot point 69, which may be read through a sight hole 75 in the angle guide 78. The guide member 7 is pivotally fixed to the angle guide 78 at a first end about common pivot point 69. Once the angle guide 78 has been fixed at the required angle, the lead screw handle 15 is then rotated to move the opposing second end of the guide member 7 until the guide member 7 abuts the angle guide 78. Adjustment of the cut depth may be provided by rotating the lead screws 14 and 15 with the angle of the angle guide being 78 maintained.

When the guide member 7 is set in position abutting the angle guide 78, the angle guide 78 is then swung away from the guide member 7, as shown in FIG. 8c, to prevent interference with the guide edge 7a and provide working clearance for the router 47. A shown in FIG. 9, the guide member 7 and angle guide 78 are pivotally mounted on a stud 81. The angle gauge plate 73 is fixed to the stud 81 vertically spaced below the angle guide 78. The lever nut 70 provides releasable locking during the angle setting process.

In an embodiment of the invention shown in FIGS. 11 and 12, a router table 105 comprises a deck frame 130 including a longitudinal frame member 100 defining the rear edge of the router table 105, and a fixed guide member 107 defining the front working edge of the router table 105. Transverse cross members 101, 102, 103 and 104 interconnect the rear frame member 100 and the front guide member 107, and diagonal cross braces 85 provide further structural rigidity. A side guide member 112 is connected at its front end to the front guide member 107 at interconnection 118 and at its rear end to the rear frame member 100, and is arranged perpendicular to the front guide member 107.

The front guide member 107 comprises a channel section 110. As shown in FIG. 11, the channel section 110 comprises a u-shaped body section 120 having an inner wall, outer wall and a base. A guide section 124 having a substantially L-shaped cross section is secured to the inner wall of the body section 120 and comprises an inner vertical wall defining a front guide edge 108, and an upper horizontal wall defining a support surface section 125 for supporting a work piece 142. A replaceable wear/collision strip 148 is secured to the upper support surface 125 such that its outer edge is horizontally aligned with the guide edge 108.

A tool support section 122, having a substantially L-shaped cross section, is connected to the outer wall of the body section 120 by a threaded locking clamp 127. The tool support section 122 comprises a vertical wall section 128 and a horizontal upper tool support section 129 for supporting a portion of the body of a router or other cutting tool A replaceable wear/collision strip 131 is secured to the upper support surface 129.

The vertical wall section 128 includes an elongate slot 133 through which a bolt portion 127a of the locking clamp 127 extends and engages with the outer wall of the body section 120. The slot 133 is substantially of equal width to the bolt section 127a. The body section 127b of the locking clamp 127 engages the vertical wall section 128 either side of the slot 127. Rotation of the locking lever 127c causes the clamp body 127b to urge against the vertical wall 128 to clamp it to the outer wall of the body section 120. When the clamp 127 is released, the slot 133 enables the tool support section to slide vertically relative to the body section 120 to adjust the height of the tool support section 122 relative to the guide member 107.

An additional guide member 112 is also provided which is oriented perpendicular to the first guide member 110 in the horizontal plane. The second guide member 112 is formed having the same channel section construction as the first guide member 110. The second guide member 112 provides a guide edge for cutting the work piece 142 in the Y axis relative to the X axis defined by the first guide member 107. This enables for example both the side and the base of a door to be cut and finished while clamped to the guide assembly 105. Adjustment of the cutting position may be made after finishing the first edge aligned with the first guide member 107 for example if the angle provided by the back stop 106 for the first edge does not correspond to the angle of cut required for the second edge.

A back stop 106 comprises an elongate member having a front facing straight abutment edge 109 for engagement by a work piece 142. The back stop 106 is slideably mounted to the transverse cross members 101 and 103 of the frame 130 by the connectors 91 and 92 respectively. The cross member 101 and 103 are channel section members having a channel formed in the upper surface thereof and define guide rails for guiding the sliding movement of the connectors 91 and 92 and hence the back stop 106. The arrangement of connectors 91 and 92 and the back stop 106 are now described with reference to connector 91 and cross member 101, although it will be appreciated that the description also applies to the connector 92 and corresponding cross member 103.

Referring to FIG. 11, the cross member 101 is connected at its front end to the inner wall of the body section 120 of the guide member 110 by a bolt or other fixing means. The lower edge of the cross member 103 has a saw-tooth profile, defining a plurality of locking points 151 along its length.

The connector 91 includes a locking section 152 which is slideably mounted to the cross-member 101 and moveable along the length thereof. The locking section 152 includes a locking member 153 which is releasably engageable with the plurality of locking points 151 to index and selectively lock the locking section 152 in a plurality of locking positions along the length of the cross member 101 defined by the locking points 151. The connector 91 further comprises an adjustable mounting 154 having a base portion which is received within and slideably mounted to the locking section 151, and an upper portion which is secured to the back stop 106.

The upper portion of the adjustable mounting 154 includes a horizontally extending barrel 156 projecting from its rear edge which includes an inner bore. The locking section 151 also includes a barrel 157 mounted to an upwardly extending flange, and having a threaded inner bore. The inner bores of each of the barrels 156 and 157 are horizontally aligned and interconnected by a threaded adjuster 155. The adjuster 155 is rotatably fixed to the barrel 156, and threadedly engaged with the barrel 157, such that rotation of the threaded adjuster 155 causes relative linear movement between the locking section 152 and the adjustable mounting 154. When the locking section 152 is locked to the cross member 101, rotation of the adjuster 155 actuates the adjustable mounting 154 to move towards and away from the locking section 152 along the length of the cross member 101 depending on the direction of rotation.

The adjustable mounting 154 includes an upper shelf 157, which extends forwardly over and is fixed to the upper edge of the back stop 106. The base of the back stop 106 is mounted on and fixed to a support surface 158 which extends forwards from the mounting 154 in sliding engagement with the cross member 101. As such, the support surface 158 is connected to and movable with the back stop 106.

A clamp 160 is mounted to the upper surface of the shelf 157. The clamp 160 includes a clamping arm 161 which extends forwardly from the shelf 157 to clamp the work piece 142 against the support surface 158. A flange headed bolt 159 extends from through the shelf 157 and back stop 106, and is slideably fixed within the channel of the cross member 101. Actuation of the clamp lever 163 causes the clamping arm 161 to move to the clamping position against the action of spring 164. When the clamp is released, the spring 164 urges the flanged bolt 150 against the cross member 101, to provide stability and prevent rattle of the connector 91 while the back stop 106 is being adjusted. Further clamps 93 and 94 are also mounted along the back stop 106, each also including a movable support surface portion 158. Unlike the clamps 160 mounted to the connectors 91 and 92, the additional clamps 93 and 94 are not engaged with and limited to movement along the cross members 102 and 104.

In use, a work piece 142 requiring modification is placed on the work piece support surface comprising the fixed support surface 125 of the guide member 110 and the movable support surface 158 of the back stop 106. The depth of cut to be applied to the work piece 142 is set by the adjusting the distance of the front abutment edge 109 back stop 106 from the guide edge 108 such that the required line of cut is aligned with the guide edge 108. The locking section 152 is moved and locked to a locking position 151 most closely corresponding to the required position of the back stop 106. A measuring guide may be provided to indicate the distance between the machine guide edge 108 and the back stop abutment edge 109. The adjuster 155 is then used for final fine adjustment of the back stop 106. This fine adjustment may be performed before or after the work piece 142 has been placed on the support surface. Once the back stop 106 has been set at the required cutting position, alignment of the required cutting line on the work piece 142 is achieved by abutting the rear edge of the work piece 142 against the back stop 106. Once the work piece 142 has been located in the cutting position, the clamps 160 are used to hold the work piece 142 in place during cutting. Alternatively, as the clamps 160 are mounted to and movable with the back stop 106, the workpiece may be abutted to and clamped relative to the back stop 106 first, and then adjusted to the cutting position by moving the back stop 106.

As described above, to perform a cut the router 147 is activated and the router bearing 150 is abutted against the guide edge 108 adjacent the cutting start point. A front portion of the work piece 142 is supported on the fixed support surface 125. The router 147 comprises a router bed 149 arranged perpendicular to the router blade 136. A first portion of the router bed 149 is supported on the work piece 142. In order to ensure a cut which is parallel to the guide edge 108, the tool support surface 129 supports the router bed 149 at level vertically aligned with the upper surface of the work piece 142 to ensure the router blade 136 is maintained parallel to the guide edge 108. To accommodate work pieces of varying thicknesses, the height of the tool support surface 129 is adjustable as described above.

During cutting, the router bearing 150 is urged against the guide edge 108 to guide the router blade 136 and maintain a straight cut. It has been found that providing a fixed guide edge 108, and setting the cutting depth with an adjustable back stop 108, is advantageous as it ensures a straight cutting line is maintained. In contrast, where an adjustable guide edge is provided, the adjustment mechanism may be prone to movement when a force is applied to it by the router guide during cutting, which can lead to the guide edge being moved out of alignment with the required cutting line during cutting. To be able to withstand the cutting forces without movement an adjustable guide edge mechanism requires high tolerances and highly durable components, which significantly increase the cost of such a mechanism. In contrast, the fixed guide edge 108 and adjustable back stop 106 arrangement of the present invention provides an accurate and cost effective means of providing a cutting guide which minimises work piece movement, and which is transportable and suitable for commercial and domestic use.

The back stop 106 is also provided with angular adjustability, to enable the angle as well as the depth of cut to be varied. The connectors 91 and 92 of the back stop 106 are independently slideably adjustable along the cross members 101 and 103 between a plurality of locking positions. To provide a cutting line along the front edge of the work piece 142 which is parallel to the rear edge of the work piece 142, the connectors 91 and 92 are fixed at corresponding locking points of equal distance from the guide edge 108 such that the back stop 106 is parallel to the guide edge 108. If a non-parallel cut is required, for example for a door which is required to fit in a non-square frame, the back stop 106 may be angled relative to guide edge 108.

To adjust the angle of the back stop 106, the connectors may be independently moved to different distances from the guide edge 108 along their respective guide rails 101 and 103 and locked in position. The enable this, the back stop is pivotally mounted to one of the connectors 91 to enable it to pivot relative to the guide edge 108. Movement of the connectors 91 and 92 from a parallel alignment increases their relative spacing. Therefore, the back stop 106 is slidingly and pivotally mounted to the second connector 92 by means of a slot provided within the back stop 106.

It will be appreciated that in further embodiments various modifications to the specific arrangements described above and shown in the drawings may be made. For example, while the cutting guide is described for use with a router, it may be used for assisting modification of a work piece by any suitable tool requiring a guide edge. In addition, while the cutting guide is described as comprising a frame structure, it may alternatively comprise for a example a solid work support surface.

What is claimed is:

1. A guide assembly for cutting a work piece with a cutting tool, the guide assembly comprising:
a support surface for a work piece;
a guide member comprising a guide edge for guiding said cutting tool; and
an adjustable stop member configured for abutment with the work piece to locate the work piece in a plurality of cutting positions relative to the guide;
wherein the guide member is positioned such that the work piece is located above the guide member when supported on the support surface and such that in the cutting position a portion of the work piece overhangs the guide edge, and the adjustable stop member is movable relative to the guide member to selectively locate the work piece in the plurality of cutting positions relative to the guide edge.

2. The guide assembly of claim 1 wherein the guide member is fixed in position.

3. The cutting guide assembly of claim 1 comprising a support frame to which the guide member and stop member are mounted.

4. The guide assembly of claim 3 wherein the guide member is fixed relative to the support frame.

5. The guide assembly of claim 3 wherein the guide member is movably mounted to the support frame and comprises an adjustment arrangement for adjusting the position of the guide member relative to a back stop.

6. The guide assembly of claim 5 wherein the adjustment arrangement comprises at least one lead screw.

7. The guide assembly of claim 3 wherein the support frame comprises at least one frame member defining a guide rail and the stop member is slideably mounted to the guide rail to enable moveable adjustment of the stop member relative to the guide edge.

8. The guide assembly of claim 7 wherein the stop member comprises at least one connector for mounting the stop member to the at least one guide rail, each connector including a locking arrangement configured for locking the stop member in a plurality of positions along the guide rail defining the plurality of cutting positions.

9. The guide assembly of claim 8 wherein the stop member is movably mounted to the locking arrangement and each connector further comprises an adjustment arrangement for selectively adjusting the position of the stop member relative to the locking arrangement to enable further positional adjustment of the stop member relative to the guide edge when the locking arrangement is locked to the guide rail.

10. The guide assembly of claim 9 wherein each guide rail comprises a plurality of locking points configured for engagement by the locking arrangement to lock the stop member in said plurality of positions.

11. The guide assembly of claim 9 wherein the stop member is slideably mounted to the locking arrangement and the adjuster comprises a threaded actuator having a first threaded portion fixed to the locking arrangement and a second threaded portion engaged with the first threaded portion and fixed to the stop member such that relative rotation of the first and second threaded portions causes movement of the stop member relative to the locking arrangement.

12. The guide assembly of claim 7 comprising two guide rails arranged parallel to each other wherein the stop member comprises two connectors mounted to said two guide rails and the stop member is pivotably mounted to a first one of the two connectors and slideably mounted to a second one of the two connectors such that the stop member is able to slide relative to the second connector while pivoting about the first connector to enable angular adjustment of the stop member relative to the guide edge by positioning said connectors at varying positions from the guide edge along said guide rails.

13. The guide assembly of claim 1 wherein the support surface defines a support plane and the stop member is linearly movable parallel to the support plane in a direction perpendicular to the guide edge to vary the depth of cut of the cutting tool.

14. The guide assembly of claim 1 wherein the support surface defines a support plane and the stop member is rotatable parallel to the support plane and relative to the guide edge to vary the angle of cut of the cutting tool.

15. The guide assembly of claim 1 further comprising at least one clamp for fixing the work piece in the cutting position.

16. The guide assembly of claim 15 wherein the at least one clamp is mounted to and movable with the stop member.

17. The guide assembly of claim 1 wherein a portion of the support surface is operably connected to and movable with the stop member.

18. The guide assembly of claim 1 wherein the guide member comprises a channel member having an inner section with an upper surface forming a portion of the support surface and an inner side wall defining the guide edge and an outer section having an upper tool support surface configured to support said cutting tool during cutting of the work piece, the inner section and outer section being interconnected at their base and defining a channel therebetween for receiving a tool bit of said cutting tool in use.

19. The guide assembly of claim 18 wherein the outer section of the channel member comprises a movable portion which is adjustable to vary the height of the tool support surface, to enable the tool support surface to be vertically aligned with the upper surface of the work piece.

20. The guide assembly of claim 1 comprising an arrangement of collapsible legs for supporting the support surface in an elevated position, the legs being collapsible from a support position to a stowed position to assist transit and/or storage.

21. The guide assembly of claim 1 claim wherein the cutting tool is a router.

22. (canceled)
